(19) United States
(12) Patent Application Publication
(10) Pub. No.: US 2002/0020328 A1
(43) Pub. Date: Feb. 21, 2002

(54) Composition and method for wall treatment

(76) Inventor: Kristen Amanda Krenz, Plymouth, MN (US)

Correspondence Address: SKINNER & ASSOCIATES, 619 SECOND STREET, SUITE 201, HUDSON, WI, 54016, US

(21) Appl. No.: 09/817,780

(22) Filed: Mar. 26, 2001

Related U.S. Application Data
(60) Provisional application No. 60/192,038, filed on Mar. 24, 2000.

(51) Int. Cl. B05D 1/36; B05D 1/28; B05D 5/06; C09C 1/02

(52) U.S. Cl. 106/465; 427/407.1; 427/428

(57) ABSTRACT

A plaster-like coating composition particularly adapted for the do-it-yourselfer or those not trained in the art of plastering or painting, containing both a binder for coating (with texture or the appearance of texture) and a colorant. The composition is applied to walls constructed of various substrates (i.e., sheetrock, plaster, wood, brick, metal, cement, or various composite structures.) to create a decorative surface which has texture or the appearance of texture and also has color. The coating composition is applied in a two to three coat process using a flat metal or plastic trowel, or one which is padded.

### CROSS-REFERENCE TO RELATED APPLICATIONS, IF ANY

This application claims the benefit under 35 U.S.C. §119(e) of co-pending provisional application Serial No. 60/192,038, filed Mar. 24, 2000, which is hereby incorporated by reference

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to construction material compositions and methods, and more particularly to a plaster-like wall or other surface coating composition which provides both texture and color, to a tool for applying the coating composition, and to a method of applying the coating composition to achieve a decorative wall finish.

2. Background Information

The state of the art includes various devices, methods and compositions related to construction, remodeling and surface finishing.

Various techniques have been proposed or used by professionals and workers highly skilled in the art of plastering and/or decorative painting, whereby texture is created using a light or heavy mud. These include spackle, sheetrock mud, joint compound or various forms of cement or plaster such as Portland Cement, White Portland cement, Keenes Cement and White Medusa Cement. Insofar as is known, such compositions have not contained color. A combination of one or more of the above mentioned mud or cement compositions is troweled onto a wall surface, then allowed to dry at least 24 hours. The wall surface thus treated is then painted with a color or a number of colors, and sometimes then treated with a number of glazes to create a textured, colored surface resembling ancient plastered or frescoed walls.

This wall treatment process requires a relatively high degree of knowledge of both the art of plastering and the art of faux painting, or at the very least some knowledge of color in order to achieve satisfactory results. In addition, should the above described surface be nicked or scraped, the damage would then need to be repaired using the plaster composition and color matched to the original color treatment used.

An alternative method for achieving such a decorative surface involves laying a plastered wall requiring a lime base, lime being a binder. This lime plaster can be tinted or painted into while wet. However, in this instance, the use of pigment is limited to mineral (calcium carbonate) pigments, as the lime will “burn” all other pigments over a period of time from the plaster. Because lime is a caustic substance, its use requires the skill of a highly trained artisan or tradesman. Also, the range of colors is limited in mineral pigments.

In summary, prior art devices and methods are believed to have significant limitations and shortcomings.

The present invention provides a ready-to-use coating composition, a tool for its application, and method of applying the composition to provide both texture and color in a simplified manner, which are believed to constitute an improvement over the known art.

### BRIEF SUMMARY OF THE INVENTION

The present invention provides a composition, method and apparatus for wall treatment which yields texture and color in one material and step.

The ready mixed, ready to use material for applying to a surface such as a wall or ceiling, comprises:

a. a latex base or binder component;

b. a Calcium Carbonate pigment component; and

c. a colorant.

The method of the invention involves applying a first coat which is a latex based flat finish paint the color being slightly darker than the subsequent two coats. This coat is applied using a conventional ½′ nap roller. A second coat is a layer of the plaster paint composition tinted to a shade slightly lighter than the first, and either slightly lighter or darker than the third coat. This coat is applied using the trowel. A third coat is also made up of the plaster paint composition, this coat being a slightly lighter or darker shade than the second coating, but definitely lighter than the first coat of flat latex paint. This coat is applied using a trowel.

The features, benefits and objects of this invention will become clear to those skilled in the art by reference to the following description, claims, and drawings.

### BRIEF DESCRIPTION OF THE SEVERAL VIEWS OF THE DRAWING

FIG. 1 illustrates a surface coated with the composition of the present invention, prepared by the method of the present invention, and showing a first exemplary color.

FIG. 2 illustrates a surface coated with the composition, prepared by the method, and showing a second color.

FIG. 3 illustrates a surface coated with the composition, prepared by the method, and showing a third color.

FIG. 4 illustrates the trowel of the present invention.

FIG. 5 is a top view of the trowel illustrated in FIG. 4.

FIG. 6 illustrates a step in the method of the present invention.

FIG. 7 illustrates a step in the method.

FIG. 8 illustrates the composition of the present invention being applied to a wall surface in the method of the present invention.

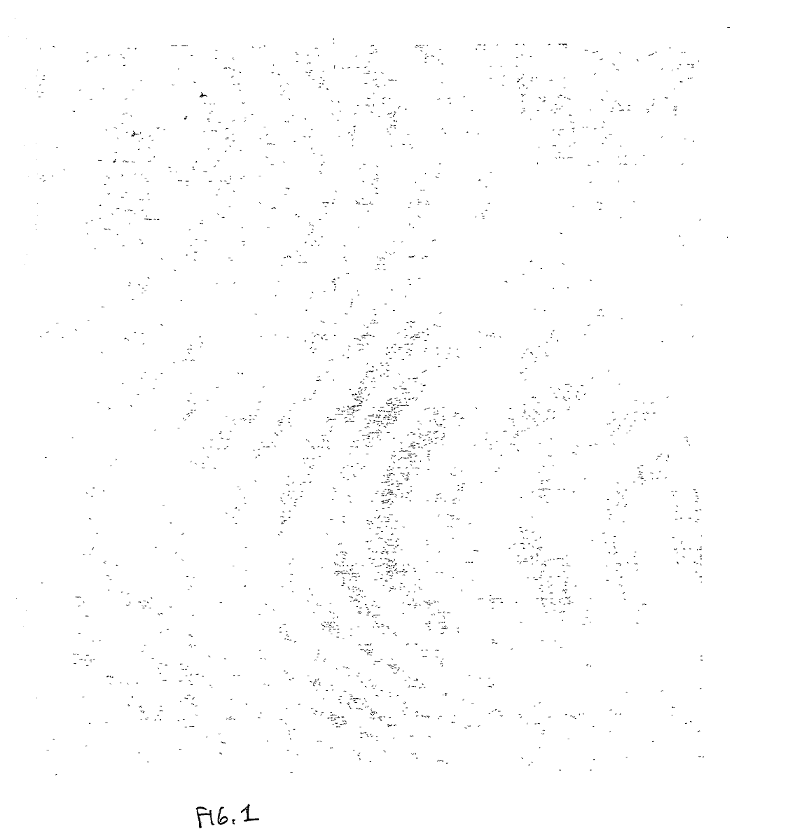

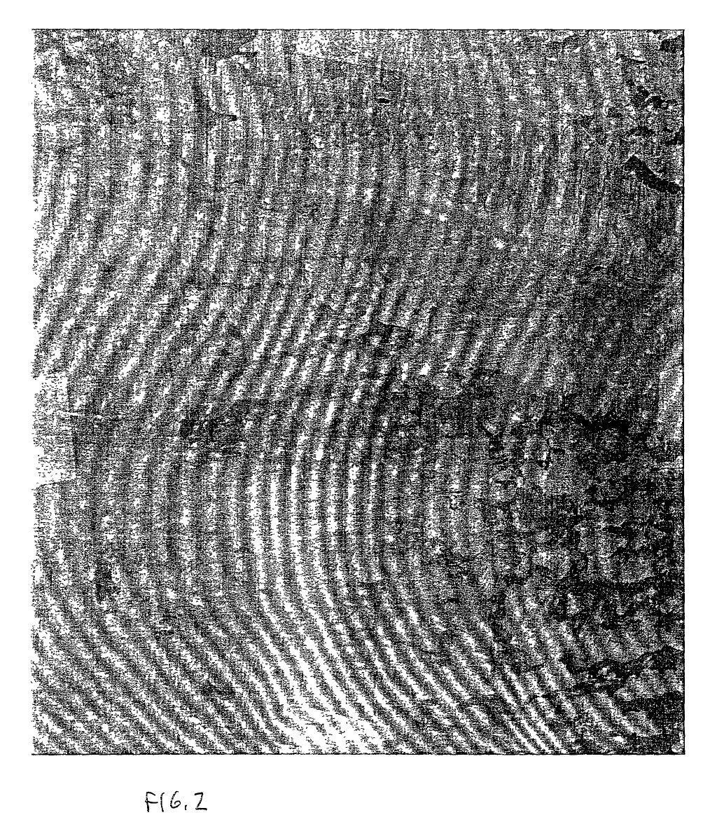

### DETAILED DESCRIPTION

1. Composition of the Invention.

The invention includes a ready-to-use, easy to apply, composition having coating, coloring and texture properties for use on a variety of wall substrates. The basic composition comprises:

a. a latex binder component;

b. a calcium carbonate pigment component; and

c. a colorant component.

The latex binder component is Hirshfield's No. BP 1190. Alternatively, it may comprise at least one member of a group consisting of homo or copolymers of ethylenically unsaturated monomers such as vinyl esters, styrene, ethylene, or vinyl chloride, neoprene, chloroprene, and styrene-betadiene copolymers. The latex binder component is provided between 20% and 80% by volume.

The pigment component is selected from at least one member of a group consisting of gneiss, dolomite, trachyte, diabase, basalt, syenite, granite, quartz, feldspar, limestone, slate, marble, porphyry and sandstone. The pigment component is provided between 20% and 80% by volume.

The colorant component is a powered mineral pigment, a mineral tint, or a liquid colorant. The colorant component is provided between 2% and 10% by volume.

The composition may further comprise at least one member of a first group consisting of Pyrex, chopped fiberglass, flint, crown glass, silicone dioxide, silica sand, titanium dioxide, paper and wood pulp. If provided, they are preferably provided in a proportion of between 0.001% and 10% by volume.

Finally, the composition may further comprise at least one member of a second group consisting of water, filler, extenders, thickening agents, coalescence promoters, surfactants, foam inhibitors, biocides, mildewcides, and pH adjusters.

2. Example of Composition and Method of Use.

The coating composition was tested in a room measuring 4 feet by 8 feet, one 4 foot wall being cement block having been treated with plaster and the remaining walls being sheetrock. The walls were treated first with one coat of latex flat finish paint, in a color compatible with the coating composition. After drying for approximately 2 hours, the wall were troweled with one coat of the coating composition—troweled on lightly with areas of the flat base coat exposed. The walls were then allowed to dry for approximately one hour. A third coat comprised a second layer of the coating composition in a slightly lighter complimentary color, lightly troweled over the first troweled coat of the coating composition. Again allowing for areas of the finish of the first two coats to be exposed. Because each coat of finish is a slightly different color, the room has a great deal of depth texture without actually requiring “actual” texture.

In the test, the troweled composition was troweled on the wall using a padded metal trowel similar to those used in tile grouting. This trowel combined with the coating composition itself creates a subtle to more pronounced texture on the wall depending on the angle of the trowel.

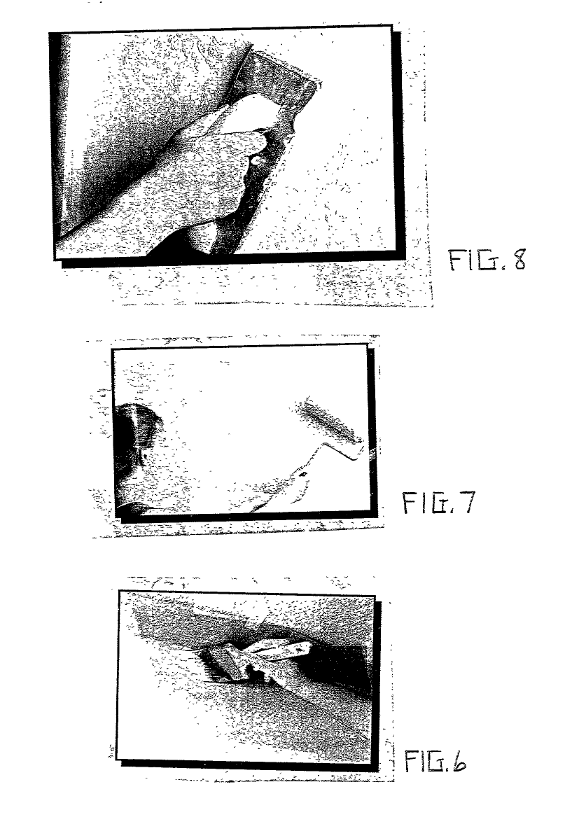

In general, the method of the invention involves application of layers and the choice of colors. Referring to FIGS. 6-8, a first coat is a latex based flat finish paint the color being slightly darker than the subsequent two coats. This coat is applied using a conventional brush and a ½″ nap roller. A second coat is a layer of the plaster paint composition tinted to a shade slightly lighter than the first, and either slightly lighter or darker than the third coat. This coat is applied using the trowel. A third coat is also made up of the plaster paint composition, this coat being a slightly lighter or darker shade than the second coating, but definitely lighter than the first coat of flat latex paint. This coat is applied using the trowel.

The method of applying the plaster paint composition can be done using either the purchase of an existing “grout float” or a specially designed trowel which is described below. However, application of the composition is not limited to the use of this above described trowel, one can also achieve a more marble-like, smooth finish using a flat, unpadded metal or plastic trowel.

There are a number of advantages to the composition and method of application.

First, because the trowel and the coating composition together create the texture and because the coating composition is itself somewhat light compared to currently available compositions, this composition and its tool can be used by even the most inexperienced layman.

Second, because the coating composition is made with a latex base, the surface treated with this composition can be washed with soap and water.

Third, because the color extends all the way through the composition, marks or abrasions can be easily repaired by sanding the surface with a fine sandpaper or by touch up with more of the composition without the need to “match” the previous coat of composition.

Fourth, should a large gouge appear because of abuse, such damage can be easily “touched up” with more composition without the need for matching the previous wall as the inherent texture or appearance of texture camouflages such repairs.

Fifth, because the composition is ready mixed and colorant is added at the point of purchase to a color chosen to compliment the base coat, it is extremely convenient, easy and inexpensive to use.

Sixth, because the composition is ready mixed and ready to use there is little mess involved in its use.

Seventh, because the composition is prepared using a latex base, rather than lime as its binder, the composition is without the caustic qualities usually associated with lime based plasters.

Eighth, because the composition does not employ lime as its binder, any number of tints or pigments can be used without the disadvantage of the pigment or color being “burned” from the composition.

Ninth, because the composition does not require “actual” texture to have the ‘appearance’ of texture, a fairly light application of the product is sufficient to acquire the desired results.

Tenth, because the composition is such that it will accept the addition of glazes, waxes and light washes of paint or stains, many varying effects can be achieved, should such be desired.

Eleventh, because the composition is able to hide flaws in the surface because of the nature of its textured appearance, walls which have been damaged or imperfect can be easily and economically made aesthetically beautiful again.

3. Trowel Apparatus for Applying Composition

The trowel is generally of the same type of trowel as is used for the grouting of tile, known in the trade as a “rubber float trowel”. The trowels currently on the market are usually a metal sheet with a plastic or wooden handle attached to the top of the metal sheet. Attached to the bottom side of the metal sheet is a layer of foam rubber approximately ⅜″ to ⅝″ in thickness with additional sheet of smooth rubber sheeting attached to the foam rubber approximately 1/16″ to ⅛″ in thickness.

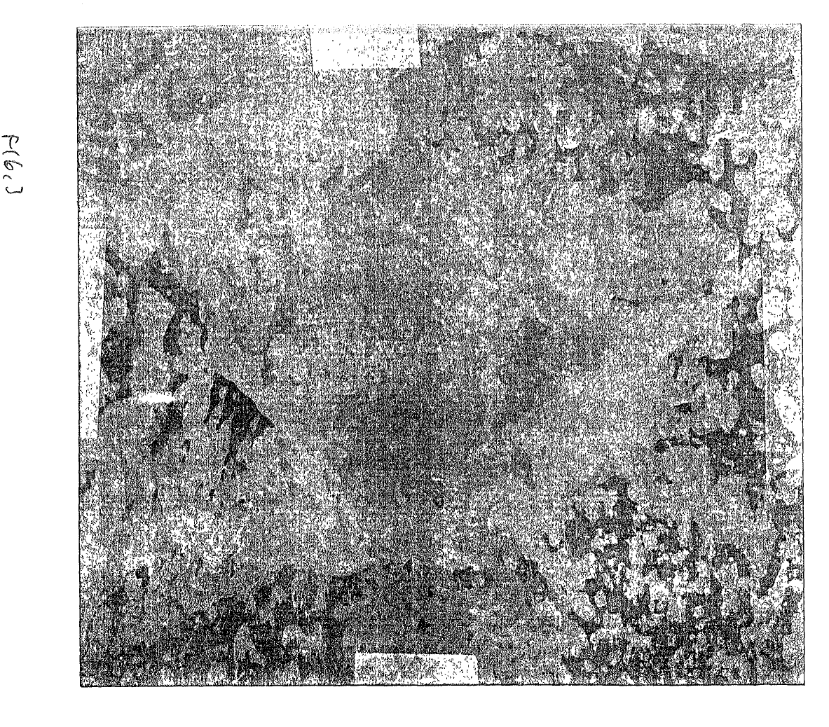

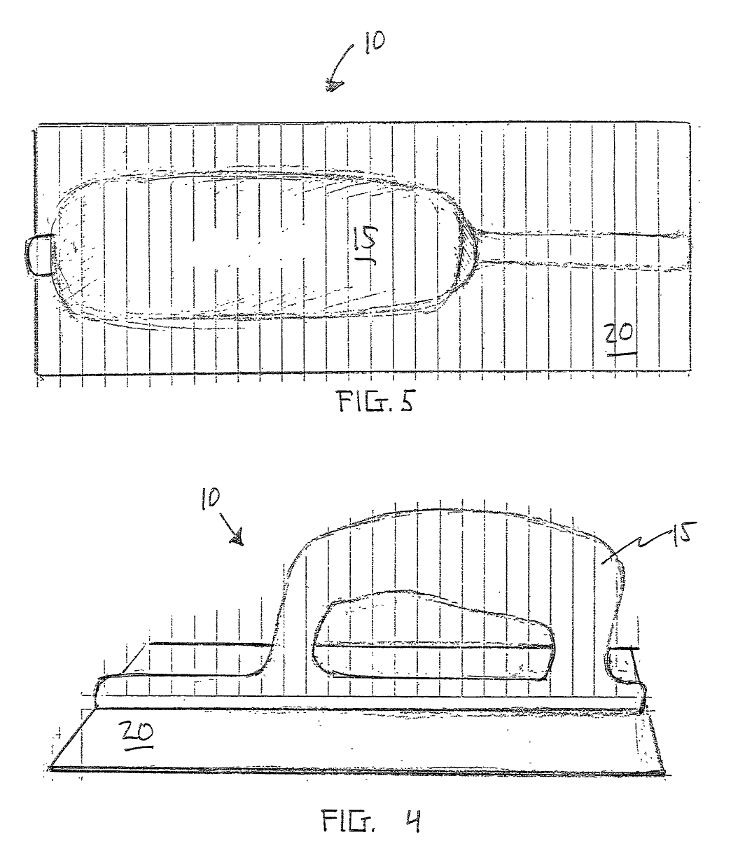

Referring to FIGS. 4 and 5, the trowel 10 of the present invention comprises a plastic handle 15 and sheet 20 all in one with the addition of the foam rubber pad and smooth rubber sheeting attached to the bottom of the trowel 10.

This design is advantageous for a number of reasons.

First, the design of the handle is particularly comfortable for use by the layman or professional alike, but especially so for the professional who might be using such a tool for many hours at a time.

Second, because the trowel itself is all one piece there is little spent on assembly in its manufacture reducing the cost both to make it and to purchase it.

Third, because the trowel is made of plastic it is easily cleaned, as various coatings are less apt to adhere to plastic, and there is no problem with rust.

Fourth, this same trowel can also be produced without incorporating the use of the foam rubber and rubber sheeting creating a smooth, hard surface for use in various troweling techniques and trades.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. A composition, comprising:
a. a latex binder component;
b. a calcium carbonate pigment component; and
c. a colorant component.

2. The composition of claim 1, wherein the latex binder component is Hirshfield's No. BP1190.

3. The composition of claim 1, wherein said latex binder component comprises at least one member of a group consisting of homo or copolymers of ethylenically unsaturated monomers such as vinyl esters, styrene, ethylene, or vinyl chloride, neoprene, chloroprene, and styrene-betadiene copolymers.

4. The composition of claim 1, wherein the latex binder component is provided between 20% and 80% by volume.

5. The composition of claim 1, wherein the pigment component is selected from at least one member of a group consisting of gneiss, dolomite, trachyte, diabase, basalt, syenite, granite, quartz, feldspar, limestone, slate, marble, porphyry and sandstone.

6. The composition of claim 1, wherein the pigment component is provided between 20% and 80% by volume.

7. The composition of claim 1, wherein the colorant component is a powered mineral pigment.

8. The composition of claim 1, wherein the colorant component is a mineral tint.

9. The composition of claim 1, wherein the colorant component is a liquid colorant.

10. The composition of claim 1, wherein the colorant component is provided between 2% and 10% by volume.

11. The composition of claim 1, further comprising at least one member of a first group consisting of Pyrex, chopped fiberglass, flint, crown glass, silicone dioxide, silica sand, titanium dioxide, paper and wood pulp.

12. The material of claim 11, wherein said at least one member of a first group is provided in a proportion of between 0.001% and 10% by volume.

13. The material of claim 1, further comprising at least one member of a second group consisting of water, filler, extenders, thickening agents, coalescence promoters, surfactants, foam inhibitors, biocides, mildewcides, and pH adjusters.

14. A ready-to-use, easy to apply, composition having coating, coloring and texture properties for use on a variety of wall substrates, comprising:
a. a latex binder component between 20 and 80 percent by volume;
b. a Calcium Carbonate pigment component between 20 and 80 percent by volume; and
c. a colorant component between 2 and 10 percent by volume.

15. A method of coating a surface to provide texture and color, comprising:
a. applying a first coat to the surface consisting of a latex based flat paint of a having a predetermined shade, the application being made with a nap roller;
b. applying a second coat to the surface as a layer of a composition comprising:
i. a latex binder component;
ii. a calcium carbonate pigment component; and
iii. a colorant component,
the composition being tinted to a shade being lighter than the shade of the first coat, the second coat being applied with a trowel; and
c. applying a third coat to the surface as a layer of the composition, the composition being tinted to a shade being lighter than the shade of the first coat of flat latex-paint, the third coat being applied with a trowel.
